(19) United States
(12) Patent Application Publication
(10) Pub. No.: US 2023/0067842 A1
(43) Pub. Date: Mar. 2, 2023

(54) TIME SERIES ANOMALY DETECTION AND VISUALIZATION

(71) Applicants: AT&T Intellectual Property I, L.P., Atlanta, GA (US); AT&T Mobility II LLC, Atlanta, GA (US)

(72) Inventors: Changchuan Yin, Hoffman Estates, IL (US); Sachin Lohe, Allen, TX (US)

(21) Appl. No.: 17/463,950

(22) Filed: Sep. 1, 2021

(51) Int. Cl. H04L 12/26; H04W 24/10; H04W 24/08

(52) U.S. Cl. CPC H04L 43/0876; H04L 43/06; H04L 43/04; H04W 24/10; H04W 24/08

(57) ABSTRACT

A processing system including at least one processor may generate a plurality of subsequences of a time series data set, convert the plurality of subsequences to a plurality of frequency domain point sets, compute pairwise distances of the plurality of frequency domain point sets, project the plurality of frequency domain point sets into a lower dimensional space in accordance with the pairwise distances, where the projecting maps each of plurality of frequency domain point sets to a node of a plurality of nodes in the lower dimensional space, and generate a notification of at least one isolated node of the plurality of nodes, where the at least one isolated node represents at least one anomaly in the time series data set.

The present disclosure relates generally to detecting anomalies in time series data, particular for telecommunication network equipment operations, and more specifically to methods, computer-readable media, and apparatuses for generating a notification indicating at least one anomaly in a time series data set.

### BACKGROUND

Anomalies are patterns in data that do not conform to a well-defined notion of normal behavior. Anomaly or outlier detection identifies rare events or observations which differ significantly from most of the data. Anomaly detection in time series may be formulated as finding outlier data points relative to a standard or usual signal. Anomaly detection in data sets may render actionable information in various application domains such as telecommunication network equipment performance, biometric/medical data, etc. For example, an anomalous traffic pattern in a computer network could indicate a hacking activity, and an anomalous signal in biometric data may indicate a medical condition or disease.

The present disclosure describes methods, computer-readable media, and apparatuses for generating a notification indicating at least one anomaly in a time series data set. For instance, in one example, a processing system including at least one processor may generate a plurality of subsequences of a time series data set, convert the plurality of subsequences to a plurality of frequency domain point sets, and compute pairwise distances of the plurality of frequency domain point sets. The processing system may then project the plurality of frequency domain point sets into a lower dimensional space in accordance with the pairwise distances, where the projecting maps each of plurality of frequency domain point sets to a node of a plurality of nodes in the lower dimensional space, and generate a notification of at least one isolated node of the plurality of nodes that represents at least one anomaly in the time series data set.

### BRIEF DESCRIPTION OF THE DRAWINGS

The present disclosure can be readily understood by considering the following detailed description in conjunction with the accompanying drawings, in which:

FIG. 1 illustrates one example of a system related to the present disclosure;

FIG. 2 illustrates an example graph of a database throughput time series data set in the time domain, and a graph of nodes representing Fourier/frequency domain power spectra of sliding window subsequences of the database throughput time series;

FIG. 3 illustrates an additional example graph of a database throughput time series data set in the time domain, and an additional example graph of nodes representing Fourier/frequency domain power spectra of sliding window subsequences of the database throughput time series;

FIG. 4 illustrates an example flowchart of a method for generating a notification indicating at least one anomaly in a time series data set; and

FIG. 5 illustrates a high-level block diagram of a computing device specially programmed to perform the functions described herein.

To facilitate understanding, identical reference numerals have been used, where possible, to designate identical elements that are common to the figures.

### DETAILED DESCRIPTION

The present disclosure broadly discloses methods, non-transitory (i.e., tangible or physical) computer-readable storage media, and apparatus for generating a notification indicating at least one anomaly in a time series data set. Anomaly detection in data sets may render actionable information in various application domains such as telecommunication network equipment performance, biometric/medical data, etc. For example, an anomalous traffic pattern in a computer network could indicate a hacking activity, and an anomalous signal in biometric data may indicate a medical condition or disease. Current techniques for time series anomaly detection may include forecasting methods, e.g., Facebook® Prophet, long short-term memory (LSTM), and the isolation forest method. However, these techniques look for individual data points that are different from normal distributed points, but do not consider the local context of each data point, leading to inaccuracies in identifying anomalies. For instance, these techniques may produce many false positives, which may preclude confident use in various application domains.

Examples of the present disclosure accurately identify anomalies in time series data sets by rendering the time series data sets in a different space, e.g., the frequency domain, and revealing features of the time domain that are only exposed in the frequency domain. Signal processing techniques, such as the Fourier transform may be used to obtain an entirely different space of coefficients where the data can be analyzed. In one example, for a given time series data set (also referred to herein as simply a “time series”), the present disclosure generates subsets/subsequences of values of the time series using a sliding window. In particular, the present disclosure obtains a plurality of of subsequences from the time series, where each subsequence has the same length as the sliding window. If the sliding window size is m, a time series of length N can generate N−m+1 subsequences, and each subsequence has the length of m. The size of the sliding window determines the number of the subsequences generated, and therefore determines the resolution of the shape of the time series.

In one example, a discrete Fourier transform (DFT) is used to transform a signal from time domain to frequency domain and reveals periodic signals that are hidden in the time domain. The Fourier transform gives a unique representation of the original underlying signal in frequency domain, while containing all the information about the signal in time domain. For a signal of length N, denoted as x(n), n=0, 1, 2, . . . , N−1, the DFT of signal x(n) is defined as:

$$X ( k ) = {\sum }_{n = 0}^{N - 1} x ( n ) {e}^{- i \frac{\text{?}}{\text{?}} kn} , k = 0 , 1 , 2 , … , N - 1 \qquad Equation 1$$

$$where , i = \sqrt{- 1}$$

$$\text{?} \text{indicates text missing or illegible when filed}$$

In Equation 1, X(k) is the DFT of x(n). Thus, the present disclosure may determine a DFT of each subsequence from the time series, where each DFT comprises a set of points in the frequency domain.

The present disclosure may then compute the pairwise distances of power spectra of these frequency domain points sets. Specifically, for a given signal, the power spectrum gives the energy distribution of the signal within given frequency bins. The power spectrum of a signal is calculated as the magnitude squared of the Fourier transform of the signal of interest. The power spectrum PS(k) of signal x(n), n=0, 1, 2, . . . , N−1, is defined as:

PS(k)=|X(k)|²=X(k)X*(k) Equation 2:

In Equation 2, X(k) is the DFT of x(n) and X*(k) is the complex conjugate of X(k). When calculating the distance of two subsequences using Fourier power spectra, the first item, i.e., PS[0] may be removed because it is the sum of the subsequence. Thus, a time series can produce sliding-window subsequences and the corresponding Fourier power spectra. The resulting Fourier power spectra are a point set in high-dimensional space. Therefore, the time series may be translated into a high-dimensional point set from which pairwise distances of the point sets may be computed.

Given a point set, PS=p₁, p₂, . . . , pk in a fixed-dimensional Euclidean space, the distance of two points pᵣ, pₜ in a Euclidean space Rₙ may be defined as:

$${d}_{rt} = \vert {p}_{r} - {p}_{t} \vert = \sqrt{{\sum }_{i = 1}^{n} {\vert {p}_{r , i} - {p}_{t , i} \vert}^{2}} \qquad Equation 3$$

Thus, using Equation 3 the pairwise dissimilarity distances of the points from Fourier power spectra may be calculated. In addition, a distance matrix of all of the pairwise distances of respective pairs of power spectra may be constructed.

In one example, the present disclosure determines relative positions of the point sets in a lower dimensional space. In particular, in one example, the present disclosure applies multidimensional scaling (MDS) to project the distance matrix into an abstract Cartesian map that preserves the distances. The MDS algorithm relies the fact that a coordinate matrix P can be approximately derived by eigenvalue decomposition from the Gramian matrix B=PP^{T}. The Gramian matrix B can be constructed from a proximity matrix D (e.g., the “distance matrix”) by multiplying the squared proximities of D, D⁽²⁾=[d²], with the centering matrix

$$C = {I}_{n} - \frac{1}{n} {J}_{n} ,$$

where Iₙ is the identify matrix of size n and Jₙ is an n×n matrix of all 1's, according to the formula

$$B = - \frac{1}{2} C {D}^{( 2 )} C .$$

An m-dimensional spatial configuration of the n objects is derived from the coordinate matrix P=EₘΛₘ^{1/2}, where Eₘ is the matrix of m eigenvectors and Λₘ is the diagonal matrix of m eigenvalues of B, respectively.

Notably, after projecting into the lower dimensional space, outlier points may be identified that are indicative of one or more anomalies in the original time series data set. In addition, points in the lower dimensional space may also be clustered via a clustering algorithm, such as density-based spatial clustering of applications with noise (DBSCAN). For instance, DBSCAN can discover clusters of different shapes and sizes from a large amount of data, which may contain noise and anomalies/outliers. DBSCAN groups points based on a distance measurement and a minimum number of points. It can mark the outlier points that are in low-density regions. In one example, the clusters may be further linked together. For instance, a clustering network may be constructed that provides spatio-temporal representations of the data shape. To illustrate, in the resulting graph, a node may represent a group of samples that are clustered together, and a link may be added between two nodes if they share any common samples in their clusters. The resulting shape graph provides a compressive representation of the time series after being transformed, and demonstrates the anomalies and fundamental shape of the time series.

In one example, the graph may be constructed using a Mapper technique, such as described in U.S. Pat. No. 8,972,899 issued Mar. 3, 2015 to Carlsson et al. The outliers in the point set, which appear as isolated nodes from DBSCAN clusters, can be identified, and may then be traced back to corresponding time series points according the position(s)/index(es) of corresponding subsequence(s) in the time series. Notably, some nodes in the graph may be disconnected from clustered components, where points contained in the nodes are considered as representing one or more anomalies or outliers because these nodes are far from the other clustered components. The corresponding indices of the windowed subsequences in the time series are the locations (times/positions) of the anomalies in the time series. Because a time series point is contained in multiple subsequences, if the point is an anomaly, there can be multiple anomaly outlier nodes in the graph. The shared position in the sliding windows of the multiple anomaly outlier nodes is the actual position of the anomaly. Therefore, the anomaly in a time series can be identified in real time.

In one example, a color map is used to color the clusters in the graph, wherein a color corresponds to the position of each subsequence in the original time series. Therefore, the anomalies in the time series can be identified and mapped onto the time series. Notably, examples of the present disclosure may significantly reduce false positives in anomaly detection. Examples of the present disclosure may also provide insights on data features from the shape of the time series in a different domain space, where these features may be hidden in the time domain. In particular, examples of the present disclosure consider the particular sequence context and signal periodicity in the frequency domain, and the shape of the time series in the frequency domain. Therefore, the identified anomalies more correctly reflect the unusual events in the time series.

Examples of the present disclosure may be employed in telecommunication network operation and automation (e.g., artificial intelligence for information technology (IT) operations (AIOps)). As just one example, the present disclosure may be applied to database system performance for automatic monitoring, alerting, reconfiguring, and so forth. For instance, an important network performance metric is database instance throughput, which may be collected and stored as a time series data set. The anomaly detection of the present disclosure may be embedded in an alerting system to notify network operations personnel if sudden increases, drops, or other changes occur. Using a static threshold based on average values or time series prediction may perform poorly because there may be many false-positives due to different loads during different times of day, days of the week, etc. In contrast, anomaly detection according to the present disclosure eliminates these shortcomings by considering the local and global data shape in the time series. Examples of the present disclosure may alternatively or additionally include monitoring, alerting, and/or reconfiguring of a telecommunication network with respect to other device utilization metrics, such as peak or average central processing unit (CPU) usage, memory usage, line card usage, or the like per unit time, peak or average device temperature, etc., radio access network (RAN) metrics, such as peak or average number of radio access bearers, average or peak upload or download data volumes per bearer and/or per connected user equipment (UE)/endpoint device, etc., metrics that may be used for intrusion detection/alerting, such as peak or average number of connection requests to a server, link utilization metrics (e.g., peak or average bandwidth utilization in terms of total volume or percentage of maximum link capacity), and so on. Thus, the present disclosure provides for fast, unsupervised machine learning and reduces time in network analytics (e.g., to eliminate false positives, or the like).

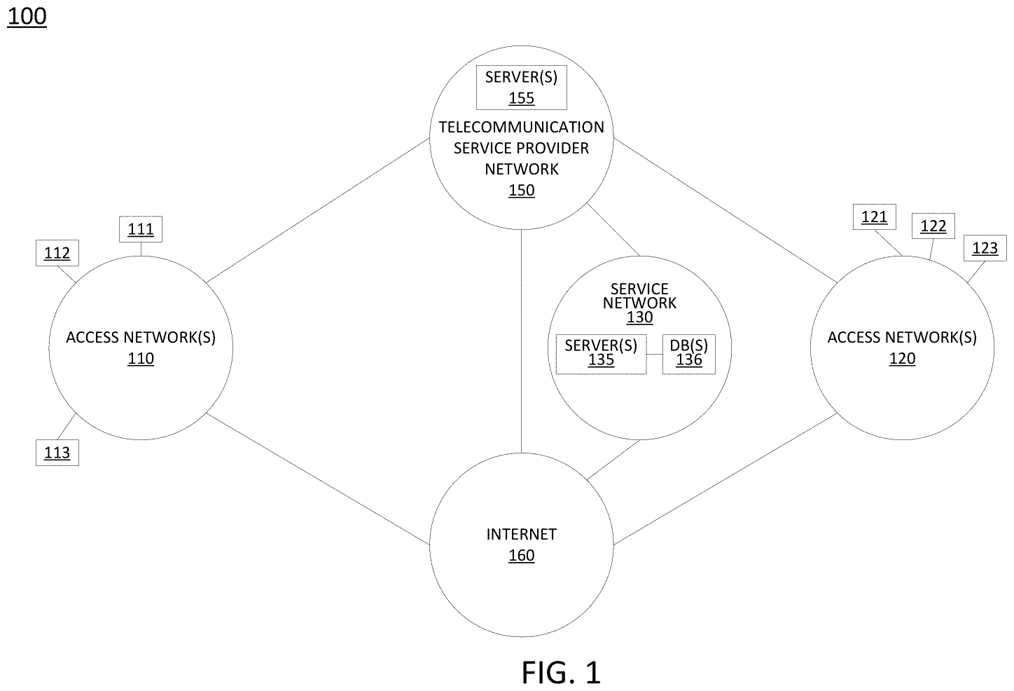

Examples of the present disclosure may also provide anomaly detection and alerting for biometric/medical time series data sets, transportation system time series data sets, weather, environmental, and/or geological time series data sets, epidemiological time series data sets, astronomical time series data sets, vehicular, machinery, or other equipment time series data sets, and so on. For instance, electrocardiogram (ECG/EKG) data, pulse data, blood oxygen level data, cholesterol data, sleep/wake data, blood pressure data, movement data (e.g., number of steps, number of pedals, etc.), or the like may be collected from one or more wearable biometric devices of a user. Accordingly, anomalies detected in such time series data sets via examples of the present disclosure may then be alerted to a user device and/or a medical provider indicative of a potential health/medical issue. In addition, in one example, a user device may also take one or more automated actions in response to anomaly alerting, such as dispensing medication, providing an instruction or suggestion for a particular medication or dosage, adjusting network-connected environmental controls, such as adjusting a thermostat, playing sounds via the user device or a network-connected speaker, increasing light levels or turning on lights to keep a user alert, and so forth. These and other aspects of the present disclosure are discussed in greater detail below in connection with the examples of FIGS. 1-5.

To aid in understanding the present disclosure, FIG. 1 illustrates an example system 100 comprising a plurality of different networks in which examples of the present disclosure for generating a notification indicating at least one anomaly in a time series data set may operate. Telecommunication service provider network 150 may comprise a core network with components for telephone services, Internet services, and/or television services (e.g., triple-play services, etc.) that are provided to customers (broadly “subscribers”), and to peer networks. In one example, telecommunication service provider network 150 may combine core network components of a cellular network with components of a triple-play service network. For example, telecommunication service provider network 150 may functionally comprise a fixed-mobile convergence (FMC) network, e.g., an IP Multimedia Subsystem (IMS) network. In addition, telecommunication service provider network 150 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Telecommunication service provider network 150 may also further comprise a broadcast television network, e.g., a traditional cable provider network or an Internet Protocol Television (IPTV) network, as well as an Internet Service Provider (ISP) network. With respect to television service provider functions, telecommunication service provider network 150 may include one or more television servers for the delivery of television content, e.g., a broadcast server, a cable head-end, a video-on-demand (VoD) server, and so forth. For example, telecommunication service provider network 150 may comprise a video super hub office, a video hub office and/or a service office/central office.

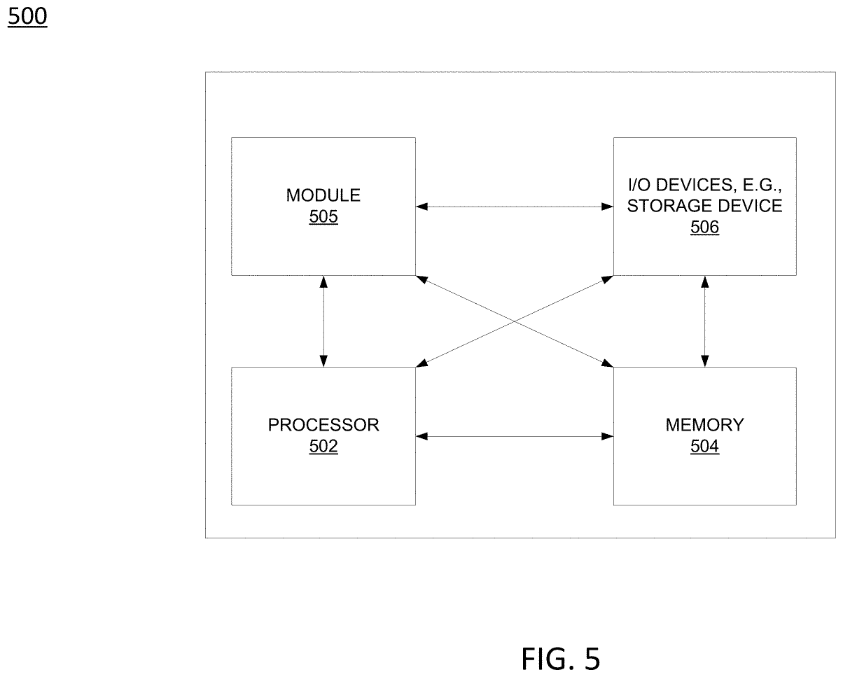

In one example, telecommunication service provider network 150 may also include one or more servers 155. In one example, the servers 155 may each comprise a computing system, such as computing system 500 depicted in FIG. 5, and may be configured to host one or more centralized system components in accordance with the present disclosure. For example, a first centralized system component may comprise a database of assigned telephone numbers, a second centralized system component may comprise a database of basic customer account information for all or a portion of the customers/subscribers of the telecommunication service provider network 150, a third centralized system component may comprise a cellular network service home location register (HLR), e.g., with current serving base station information of various subscribers, and so forth. Other centralized system components may include a Simple Network Management Protocol (SNMP) trap, or the like, a billing system, a customer relationship management (CRM) system, a trouble ticket system, an inventory system (IS), an ordering system, an enterprise reporting system (ERS), an account object (AO) database system, and so forth. In addition, other centralized system components may include, for example, a layer 3 router, a short message service (SMS) server, a voicemail server, a video-on-demand server, a server for network traffic analysis, and so forth. It should be noted that in one example, a centralized system component may be hosted on a single server, while in another example, a centralized system component may be hosted on multiple servers, e.g., in a distributed manner. For ease of illustration, various components of telecommunication service provider network 150 are omitted from FIG. 1.

In one example, access networks 110 and 120 may each comprise a Digital Subscriber Line (DSL) network, a broadband cable access network, a Local Area Network (LAN), a cellular or wireless access network, and the like. For example, access networks 110 and 120 may transmit and receive communications between endpoint devices 111-113, endpoint devices 121-123, and service network 130, and between telecommunication service provider network 150 and endpoint devices 111-113 and 121-123 relating to voice telephone calls, communications with web servers via the Internet 160, and so forth. Access networks 110 and 120 may also transmit and receive communications between endpoint devices 111-113, 121-123 and other networks and devices via Internet 160. For example, one or both of the access networks 110 and 120 may comprise an ISP network, such that endpoint devices 111-113 and/or 121-123 may communicate over the Internet 160, without involvement of the telecommunication service provider network 150. Endpoint devices 111-113 and 121-123 may each comprise a telephone, e.g., for analog or digital telephony, a mobile device, such as a cellular smart phone, a laptop, a tablet computer, etc., a router, a gateway, a desktop computer, a plurality or cluster of such devices, a television (TV), e.g., a “smart” TV, a set-top box (STB), and the like. In one example, any one or more of endpoint devices 111-113 and 121-123 may represent one or more user devices and/or one or more servers of one or more data set owners, such as a weather data service, a traffic management service (such as a state or local transportation authority, a toll collection service, etc.), a payment processing service (e.g., a credit card company, a retailer, etc.), a police, fire, or emergency medical service, and so on.

In one example, the access networks 110 and 120 may be different types of access networks. In another example, the access networks 110 and 120 may be the same type of access network. In one example, one or more of the access networks 110 and 120 may be operated by the same or a different service provider from a service provider operating the telecommunication service provider network 150. For example, each of the access networks 110 and 120 may comprise an Internet service provider (ISP) network, a cable access network, and so forth. In another example, each of the access networks 110 and 120 may comprise a cellular access network, implementing such technologies as: global system for mobile communication (GSM), e.g., a base station subsystem (BSS), GSM enhanced data rates for global evolution (EDGE) radio access network (GERAN), or a UMTS terrestrial radio access network (UTRAN) network, among others, where telecommunication service provider network 150 may provide service network 130 functions, e.g., of a public land mobile network (PLMN)-universal mobile telecommunications system (UMTS)/General Packet Radio Service (GPRS) core network, or the like. In still another example, access networks 110 and 120 may each comprise a home network or enterprise network, which may include a gateway to receive data associated with different types of media, e.g., television, phone, and Internet, and to separate these communications for the appropriate devices. For example, data communications, e.g., Internet Protocol (IP) based communications may be sent to and received from a router in one of the access networks 110 or 120, which receives data from and sends data to the endpoint devices 111-113 and 121-123, respectively.

In this regard, it should be noted that in some examples, endpoint devices 111-113 and 121-123 may connect to access networks 110 and 120 via one or more intermediate devices, such as a home gateway and router, e.g., where access networks 110 and 120 comprise cellular access networks, ISPs and the like, while in another example, endpoint devices 111-113 and 121-123 may connect directly to access networks 110 and 120, e.g., where access networks 110 and 120 may comprise local area networks (LANs), enterprise networks, and/or home networks, and the like.

In one example, the service network 130 may comprise a local area network (LAN), or a distributed network connected through permanent virtual circuits (PVCs), virtual private networks (VPNs), and the like for providing data and voice communications. In one example, the service network 130 may be associated with the telecommunication service provider network 150. For example, the service network 130 may comprise one or more devices for providing services to subscribers, customers, and/or users. For example, telecommunication service provider network 150 may provide a cloud storage service, web server hosting, and other services. As such, service network 130 may represent aspects of telecommunication service provider network 150 where infrastructure for supporting such services may be deployed. In another example, service network 130 may represent a third-party network, e.g., a network of an entity that provides a time series anomaly monitoring, detection, and/or alerting system as a service to various other entities.

In the example of FIG. 1, service network 130 may include one or more servers 135 which may each comprise all or a portion of a computing device or system, such as computing system 500, and/or processing system 502 as described in connection with FIG. 5 below, specifically configured to perform various steps, functions, and/or operations for generating a notification indicating at least one anomaly in a time series data set, as described herein. For example, one of the server(s) 135, or a plurality of servers 135 collectively, may perform operations in connection with the example method 400, or as otherwise described herein. In one example, the one or more of the servers 135 may comprise a time series anomaly detection and alerting platform (e.g., a network-based and/or cloud-based service hosted on the hardware of servers 135).

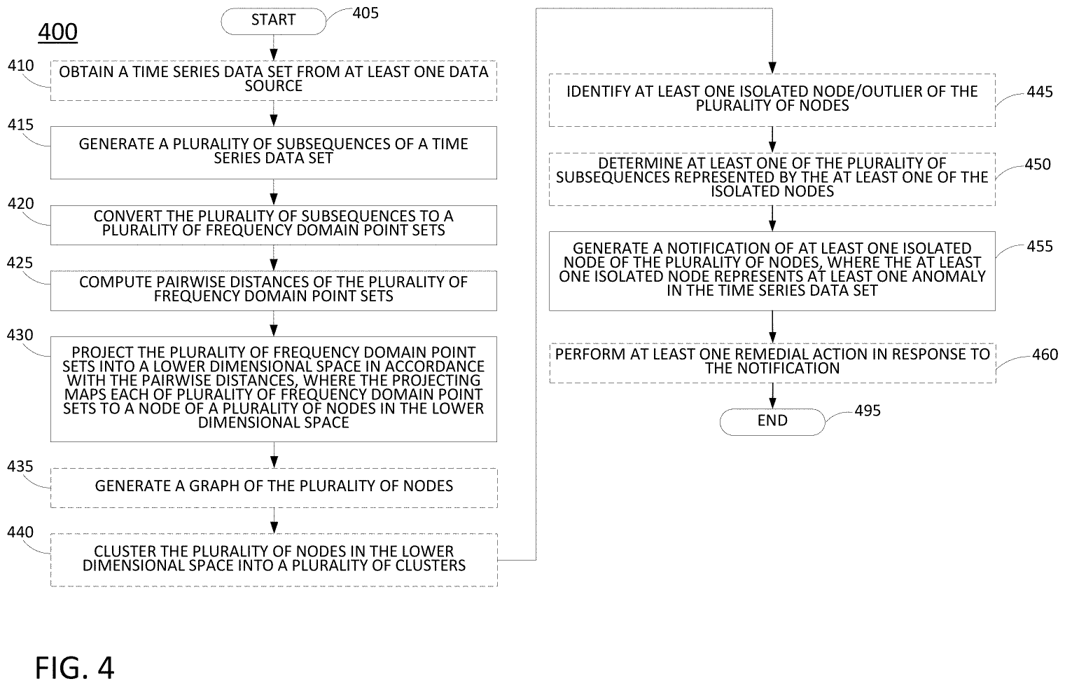

In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

In one example, service network 130 may also include one or more databases (DBs) 136, e.g., physical storage devices integrated with server(s) 135 (e.g., database servers), attached or coupled to the server(s) 135, and/or in remote communication with server(s) 135 to store various types of information in support of systems for generating a notification indicating at least one anomaly in a time series data set, as described herein. As just one example, DB(s) 136 may be configured to receive and store network operational data collected from the telecommunication service provider network 150, such as call logs, mobile device location data, control plane signaling and/or session management messages, data traffic volume records, call detail records (CDRs), error reports, network impairment records, performance logs, alarm data, and other information and statistics, which may then be compiled and processed, e.g., normalized, transformed, tagged, etc., and forwarded to DB(s) 136 directly or via one or more of the servers 135. The network operational data stored in DB(s) 136 may specifically include time series data sets, such as: database throughput of one or more database instances (such as one or more of servers 155 of telecommunication service provider network 150), peak or average central processing unit (CPU) usage, memory usage, line card usage, or the like per unit time, peak or average device temperature, etc. with respect to network-based devices (e.g., one or more of servers 155), radio access network (RAN) metrics, such as peak or average number of radio access bearers, average or peak upload or download data volumes per bearer and/or per connected user equipment (UE)/endpoint device, etc., such as from one or more of access networks 110 or 120, metrics that may be used for intrusion detection/alerting, such as peak or average number of connection requests to a server, link utilization metrics (e.g., peak or average bandwidth utilization in terms of total volume or percentage of maximum link capacity), etc.

In one example, DB(s) 136 may receive and store biometric data of one or more users. For instance, one or more of endpoint devices 111-113 or 121-123 may represent a wearable biometric device that measures and may upload pulse data, ECG/EKG data, blood oxygen level data, movement data or positional data from which movement may be measured (e.g., quantified as a time series, such as number of steps per minute, pedals per minute, linear distance traveled per minute, or the like). Alternatively, or in addition, one or more of endpoint devices 111-113 or 121-123 may represent a mobile computing device that is connected to a wearable biometric device, e.g., via IEEE 802.15 based communications (e.g., “Bluetooth”, “ZigBee”, etc.) or via other wireless peer-to-peer communications, via wired connection, etc., where the endpoint device(s) collect and transmit the biometric data from the one or more connected biometric devices. Similarly, DB(s) 136 may receive and store weather data from a device of a third-party, e.g., a weather service, a traffic management service, etc. via one of access networks 110 or 120. For instance, one of endpoint devices 111-113 or 121-123 may represent a weather data server (WDS). In one example, the weather data may be received via a weather service data feed, e.g., an NWS extensible markup language (XML) data feed, or the like. In another example, the weather data may be obtained by retrieving the weather data from the WDS. In one example, DB(s) 136 may receive and store weather data from multiple third-parties. Similarly, one of endpoint devices 111-113 or 121-123 may represent a server of a traffic management service and may forward various traffic related data to DB(s) 136, such as toll payment data, records of traffic volume estimates, traffic signal timing information, and so forth. It should be noted that in each case, the data stored by DB(s) 136 relevant to the present disclosure may specifically comprise time series data sets.

In one example, server(s) 135 and/or DB(s) 136 may comprise cloud-based and/or distributed data storage and/or processing systems comprising one or more servers at a same location or at different locations. For instance, DB(s) 136, or DB(s) 136 in conjunction with one or more of the servers 135, may represent a distributed file system, e.g., a Hadoop® Distributed File System (HDFS™), or the like. In this regard, server(s) 135 and/or DB(s) 136 may maintain communications with one or more of the endpoint devices 111-113 and/or endpoint devices 121-123 via access networks 110 and 120, telecommunication service provider network 150, Internet 160, and so forth, e.g., in order to obtain time series data sets, to transmit notifications to such devices of anomalies detected in time series data sets, and so on.

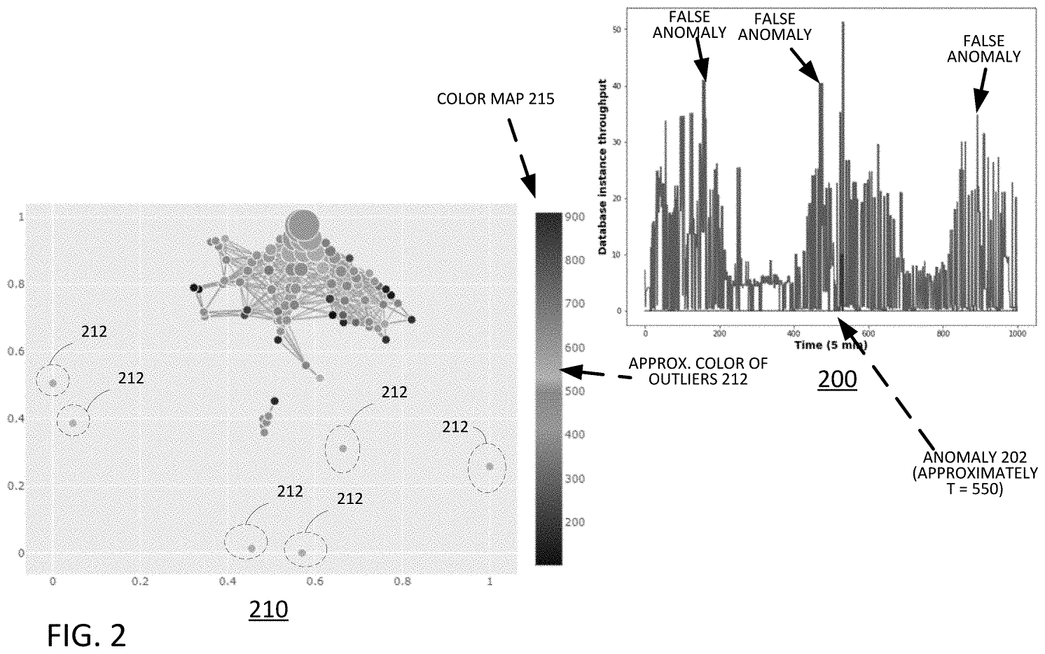

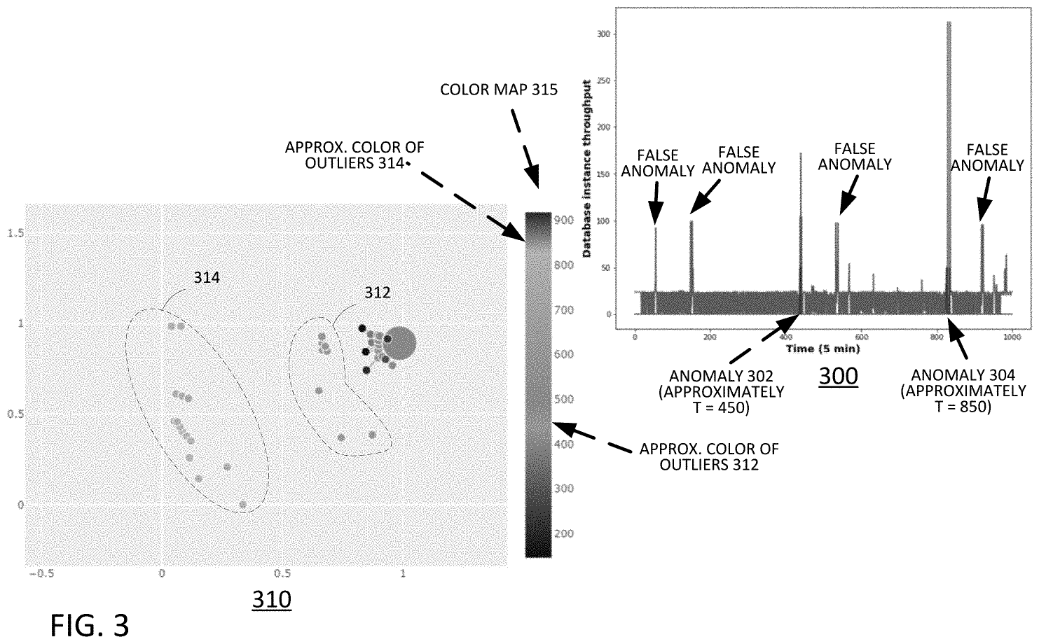

As noted above, server(s) 135 may be configured to perform various steps, functions, and/or operations for generating a notification indicating at least one anomaly in a time series data set, as described herein. For instance, an example method for generating a notification indicating at least one anomaly in a time series data set is illustrated in FIG. 4 and described in greater detail below. In addition, server(s) 135 may perform various additional operations as described in connection with either of FIGS. 2 and 3, or elsewhere herein. These operations may be with respect to telecommunication network operational data, biometric/medical data, and so forth, such as stored in DB(s) 136 or as otherwise obtained from any one or more components of the system 100.

In addition, it should be realized that the system 100 may be implemented in a different form than that illustrated in FIG. 1, or may be expanded by including additional endpoint devices, access networks, network elements, application servers, etc. without altering the scope of the present disclosure. As just one example, any one or more of server(s) 135 and DB(s) 136 may be distributed at different locations, such as in or connected to access networks 110 and 120, in another service network connected to Internet 160 (e.g., a cloud computing provider), in telecommunication service provider network 150, and so forth. Thus, these and other modifications are all contemplated within the scope of the present disclosure.

FIG. 2 illustrates an example graph 200 of a database throughput time series data set in the time domain, and a graph 210 of the point sets/nodes of Fourier/frequency domain power spectra of sliding window subsequences of the database throughput time series. In the graph 200, each time series data point represents a 5 minute measurement of database throughput. In addition, in the example of FIG. 2, the sliding window size is 6 for generating subsequences of the time series data set. In the graph 210 the color map 215 corresponds the positions of the data points in the time series of the graph 200. As can be seen in the graph 210, there are six outliers 212 (e.g., outlier points/nodes), which are manually identifiable, but which may be identified via clustering (e.g., as described above) in which a cluster includes a single power spectra data point (or a power spectra data point is assigned to a cluster with other power spectra data points). It should be noted that the outliers, such as outliers 212, may be indicative of one or more anomalies in the time series data set. However, in the present example, the color of the outliers 212 is nearly identical, and corresponds to an approximate time of T=550 in the temporal sequence of the time series. As such, these outliers 212 are indicative of a single anomaly 202 (labeled in the graph 200). Notably, the present example demonstrates that several false anomalies may be avoided. For example, these fails anomalies may likely be incorrectly identified as true anomalies by other anomaly detection techniques, such as static thresholding, LSTM, isolation forest, etc.

In the present example, an anomaly comprising a single data point in the time series (such as anomaly 202), may be included in up to 6 subsequences (if the sliding window size is 6), which may thus result in six outliers (e.g., outliers 212). It should also be noted that the example of FIG. 2 is just one example of how frequency domain visualization of anomalies of a time series data set may be presented, and that different visualizations may be provided in other, further, and different examples of the present disclosure. For instance, instead of a color map 215, a shading map may be used for a black and white only representation, different time bands may be assigned different symbols, etc. In addition, it should be noted that in one example, the temporal position of any anomaly, or anomalies, in the original time series may be determined and output (e.g., without visualization via a graph, such as graph 210). For instance, the present disclosure may color or shade the power spectra data points/nodes based on the correspondence between each power spectra data point and the time/index of the respective subsequence of the time series from which the power spectra data point is derived. In the same way, the present disclosure may instead determine outliers from the clustering, map the outliers back to the subsequences of the time series, and output the time(s)/index(es) of the subsequence(s). Alternatively, or in addition, the present disclosure may output a single time/index, such as the time of the first sample of the first outlier subsequence, and average time/index of a group of the subsequences associated with the outlier(s), and so on.

FIG. 3 illustrates an additional example graph 300 of a database throughput time series data set in the time domain, and a graph 310 of the point sets/nodes of Fourier/frequency domain power spectra of sliding window subsequences of the database throughput time series. In the graph 300, each time series data point represents a 5 minute measurement of database throughput. In addition, in the example of FIG. 3, the sliding window size is 6 for generating subsequences of the time series data set. In the graph 310 the color map 315 corresponds the positions of the data points in the time series of the graph 300.

As can be seen in the graph 310, there are a number of outliers 312 and outliers 314, which are manually identifiable, but which may be identified via clustering (e.g., as described above) in which a cluster includes a single power spectra data point (or a power spectra data point is assigned to a cluster with other power spectra data points). It should be noted that, in the present example, the color of the outliers 312 is nearly identical to each other, and corresponds to an approximate time of T=450 in the temporal sequence of the time series. Similarly, the color of the outliers 314 is nearly identical to each other, and corresponds to an approximate time of T=850 in the temporal sequence of the time series. As such, outliers 312 and outliers 314 are indicative of two anomalies 302 and 304 (labeled in the graph 300). Notably, the present example demonstrates that several false anomalies may be avoided. For example, other anomaly detection techniques may likely incorrectly identify these false anomalies. In such case, it may then be necessary to manually investigate and label these detected items as false anomalies, etc. In addition, as noted above, different visualizations may be provided which convey the same concept, such as a shading map, etc. Alternatively, or in addition, anomalies may be identified (e.g., indicated by time/index within the time series) and included in a notification/alert (e.g., without accompanying visualization, or in additional to a visual output). For instance, anomalies identified via the examples of the present disclosure may be used for automated actions, such as in a software defined network (SDN) environment where an SDN controller may automatically reconfigure one or more virtual network functions (VNFs) or other network components in response to one or more detected anomalies, and so on. In such case, a visualization such as graph 210 of FIG. 2 or 310 of FIG. 3 may be omitted, or may be provided to network personnel upon request, for instance. Thus, these and other modifications are all contemplated within the scope of the present disclosure.

FIG. 4 illustrates a flowchart of an example method 400 for generating a notification indicating at least one anomaly in a time series data set. In one example, steps, functions, and/or operations of the method 400 may be performed by a device as illustrated in FIG. 1, e.g., one or more of servers 135, or by one of endpoint devices 111-113 or 121-123. Alternatively, or in addition, the steps, functions and/or operations of the method 400 may be performed by a processing system collectively comprising a plurality of devices as illustrated in FIG. 1 such as one or more of servers 135, DB(s) 136, endpoint devices 111-113 and/or 121-123, and so forth. In one example, the steps, functions, or operations of method 400 may be performed by a computing device or system 500, and/or a processing system 502 as described in connection with FIG. 5 below. For instance, the computing device 500 may represent at least a portion of a platform, a server, a system, and so forth, in accordance with the present disclosure. For illustrative purposes, the method 400 is described in greater detail below in connection with an example performed by a processing system. The method 400 begins in step 405 and may proceed to optional step 410 or to step 415.

At optional step 410, the processing system may obtain a time series data set from at least one data source. For instance, the at least one data source may be a database storing the time series data set, one or more source devices may stream the time series data set to the processing system, the processing system may “subscribe” to a data feed comprising the time series data set (such as via Apache Kafka, or the like), and so forth. In one example, the time series data set comprises measures of a database throughput. In another example, the time series data set may comprise measures of at least one type of biometric data, e.g., from at least one wearable device of a user, such as EKG data, pulse data, blood oxygen level data, cholesterol data, sleep/wake data, blood pressure data, movement data, etc.

At step 415, the processing system generates a plurality of subsequences of a time series data set. For example, the plurality of subsequences may be taken over a sliding window over the time series data, such as 6 samples/data points, 10 samples, 20 samples, etc.

At step 420, the processing system converts the plurality of subsequences to a plurality of frequency domain point sets. In one example, the frequency domain point sets may comprise frequency domain power spectra. For instance, in one example, step 420 may include applying a Fourier transform function to the plurality of subsequences to generate a plurality of frequency domain representations (e.g., a DFT function, such as set forth in Equation 1), from which respective power spectra may then be determined (e.g., via Equation 2 above, or the like).

At step 425, the processing system computes pairwise distances of the plurality of frequency domain point sets (e.g., via Equation 3 above, or the like). For instance, in one example, step 425 may include generating a mutual distance matrix.

At step 430, the processing system projects the plurality of frequency domain point sets into a lower dimensional space (e.g., into a two-dimensional space from a higher dimensional space) in accordance with the pairwise distances, where the projecting maps each of plurality of frequency domain point sets to a node of a plurality of nodes in the lower dimensional space. For instance, step 430 may include projecting the plurality of frequency domain point sets into a lower dimensional space in accordance with a mutual distance matrix generated at step 425. In one example, the projecting of the plurality of frequency domain point sets into the lower dimensional space may comprise a multidimensional scaling (MDS). In one example, optional step 430 may include generate a graph of the plurality of nodes. For instance, the graph may plot the nodes in the lower dimensional space, e.g., a two-dimensional space.

At optional step 435, the processing system may generate a graph of the plurality of nodes. For instance, the graph may be the same or similar to the example 210 of FIG. 2 and the example 310 of FIG. 3. In one example, the plurality of nodes in the graph are colored according to a color key matching colors to time indexes of the plurality of subsequences of the time series data set represented by the respective plurality of nodes, such as illustrated in FIGS. 2 and 3, or may use a different identification scheme, e.g., as further described above.

At optional step 440, the processing system may cluster the plurality of nodes in the lower dimensional space into a plurality of clusters. In one example, step 435 may comprise a density-based spatial clustering of applications with noise-based (DBSCAN) clustering or the like. In one example, optional step 435 may include updating/modifying the graph to identify clusters and to add edges between pairs of clusters of the plurality of clusters which have at least one node of the plurality of nodes assigned to both clusters of the pair of clusters.

At optional step 445, the processing system may identify at least one isolated node/outlier of the plurality of nodes, where the at least one isolated node represents at least one anomaly in the time series data set. For instance, an isolated node may be a cluster with single node, i.e., a node that is assigned to a cluster having no other node(s). In an example in which the time series data set comprises measures of a database throughput, the at least one anomaly may comprise at least one outlier among the measures of database throughput (e.g., revealed via the isolated node(s)/outlier(s) in the frequency domain). In an example in which the time series data set comprises measures of at least one type of biometric data, the at least one anomaly may comprise at least one outlier among the measures of the at least one type of biometric data (e.g., revealed via the isolated node(s)/outlier(s) in the frequency domain). In one example, optional step 445 may include adding visual indicators to the graph to indicate the isolated nodes/outliers, such as highlighting, circling, etc.

At optional step 450, the processing system may determine at least one of the plurality of subsequences represented by the at least one of the isolated nodes. In one example optional step 450 may include determining a time of the at least one anomaly in the time series, where the time is associated with a time index of the at least one of the plurality of subsequences. For instance, in one example, the time could just be the index, or can be referenced back into a time/position with the time series, an actual time of the subsequence within the time series, etc. The time can be a time of a start of a subsequence, can be a time of a midpoint of subsequence, can be a time of an end of subsequence, can be a time block of a subsequence, e.g., simply indicating the 30 minutes within which the anomaly occurs if each data point is 5 minutes and the window is 6 data points of the time series, etc.

At step 455, the processing system generates a notification of at least one isolated node of the plurality of nodes (such as identified at optional step 445 above). In one example, the notification includes an indication of a time of the at least one anomaly in the time series (such as identified at optional step 450 above). In one example, the notification may comprise a graph of the plurality of nodes (such as generated at optional step 435 and/or as further enhanced, modified, and/or generated via optional step 440 and/or step 445). In an example in which the time series data comprises biometric data, the notification may be sent to at least one of a device of a user from which the biometric data is collected or a computing system of at least one medical provider associated with the user. For example, the device of the user may then take automated actions in accordance with notification.

At optional step 460, the processing system may perform at least one remedial action in response to the notification. For instance, in an example in which the time series data comprises measures of database throughput, the at least one remedial action may comprise changing at least one setting of a database associated with the measures of database throughput or changing at least one aspect of a communication network associated with the database, e.g., reconfigure at least one aspect of the communication network, such as rerouting traffic, adding new VNF(s), load balancing between database servers, etc. Alternatively, in an example in which the time series data comprises biometric data, the processing system may comprise the device of a user, which can determine the anomaly and take remedial action accordingly, e.g., automatically dispense medication, adjust environmental controls, play sound, increase or turn on lights to keep user alert, etc.

Following step 455, or optional step 460, method 400 ends in step 495. It should be noted that method 400 may be expanded to include additional steps, or may be modified to replace steps with different steps, to combine steps, to omit steps, to perform steps in a different order, and so forth. For instance, in one example, the processing system may repeat one or more steps of the method 400, such as steps 410-455, steps 410-460, etc. for a different time series data set, or data sets, for additional time series data of the same time series data set, and so on. In one example, step 435 may be performed after one or more of steps 440-450. In another example, the method 400 may relate to another type of time series data of a telecommunication network, such as CPU usage, memory usage, line card usage, device temperature, etc., RAN metrics, metrics that may be used for intrusion detection/alerting, link utilization metrics, and so forth, such as described above. In such examples, anomalies identified via the method 400 may trigger automated actions at optional step 460, such as the processing system (which may comprise an SDN controller or the like) automatically reconfiguring one or more VNFs or physical network component(s), deploying new VNF(s), and so on. For instance, a detected anomaly may be an overloaded serving gateway (SGW), and the remedial action may be to instantiate a new virtual SGW (vSGW) and redirecting traffic from one or more cell sites to the new vSGW. In another example, a detected anomaly may be indicative of a denial of service (DoS) attack on a server and the remedial action may be to slow the transmission of traffic to the server from other network elements that are one or two hops from the server under attack (and which may forward traffic to/toward the server under attack). Thus, these and other modifications are all contemplated within the scope of the present disclosure.

In addition, although not specifically specified, one or more steps, functions, or operations of the method 400 may include a storing, displaying, and/or outputting step as required for a particular application. In other words, any data, records, fields, and/or intermediate results discussed in the method 400 can be stored, displayed and/or outputted either on the device executing the method 400, or to another device, as required for a particular application. Furthermore, steps, blocks, functions, or operations in FIG. 4 that recite a determining operation or involve a decision do not necessarily require that both branches of the determining operation be practiced. In other words, one of the branches of the determining operation can be deemed as an optional step. In addition, one or more steps, blocks, functions, or operations of the above described method 400 may comprise optional steps, or can be combined, separated, and/or performed in a different order from that described above, without departing from the examples of the present disclosure.

FIG. 5 depicts a high-level block diagram of a computing device or processing system specifically programmed to perform the functions described herein. For example, any one or more components or devices illustrated in FIG. 1, or described in connection with the examples of FIGS. 2-4 may be implemented as the processing system 500. As depicted in FIG. 5, the processing system 500 comprises one or more hardware processor elements 502 (e.g., a microprocessor, a central processing unit (CPU) and the like), a memory 504, (e.g., random access memory (RAM), read only memory (ROM), a disk drive, an optical drive, a magnetic drive, and/or a Universal Serial Bus (USB) drive), a module 505 for generating a notification indicating at least one anomaly in a time series data set, and various input/output devices 506, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one processor element is shown, it should be noted that the computing device may employ a plurality of processor elements. Furthermore, although only one computing device is shown in FIG. 5, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of FIG. 5 is intended to represent each of those multiple computing devices. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 502 can also be configured or programmed to cause other devices to perform one or more operations as discussed above. In other words, the hardware processor 502 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 505 for generating a notification indicating at least one anomaly in a time series data set (e.g., a software program comprising computer-executable instructions) can be loaded into memory 504 and executed by hardware processor element 502 to implement the steps, functions or operations as discussed above in connection with the example method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 505 for generating a notification indicating at least one anomaly in a time series data set (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
generating, by a processing system including at least one processor, a plurality of subsequences of a time series data set;
converting, by the processing system, the plurality of subsequences to a plurality of frequency domain point sets;
computing, by the processing system, pairwise distances of the plurality of frequency domain point sets;
projecting, by the processing system, the plurality of frequency domain point sets into a lower dimensional space in accordance with the pairwise distances, wherein the projecting maps each of plurality of frequency domain point sets to a node of a plurality of nodes in the lower dimensional space; and
generating, by the processing system, a notification of at least one isolated node of the plurality of nodes, wherein the at least one isolated node represents at least one anomaly in the time series data set.

2. The method of claim 1, further comprising:
obtaining the time series data set from at least one data source.

3. The method of claim 1, wherein the plurality of subsequences is taken over a sliding window over the time series data.

4. The method of claim 1, wherein the plurality of frequency domain point sets comprises frequency domain power spectra.

5. The method of claim 1, wherein the plurality of frequency domain point sets is projected into the lower dimensional space by a multidimensional scaling.

6. The method of claim 1, wherein the lower dimensional space comprises a two-dimensional space.

7. The method of claim 1, further comprising:
generating a graph of the plurality of nodes, wherein the notification comprises the graph.

8. The method of claim 7, wherein the plurality of nodes in the graph is colored according to a color key matching colors to time indexes of the plurality of subsequences of the time series data set represented by the respective plurality of nodes.

9. The method of claim 1, further comprising:
clustering the plurality of nodes in the lower dimensional space into a plurality of clusters, wherein the at least one isolated node is assigned to a cluster having no other nodes.

10. The method of claim 9, further comprising:
identifying the at least one isolated node of the plurality of nodes.

11. The method of claim 10, further comprising:
determining at least one of the plurality of subsequences represented by the at least one isolated node of the plurality of nodes, wherein the notification includes an indication of a time of the at least one anomaly in the time series data set, wherein the time is associated with a time index of the at least one of the plurality of subsequences.

12. The method of claim 9, wherein the clustering of the plurality of nodes in the lower dimensional space into the plurality of clusters comprises a density-based spatial clustering of applications with noise-based clustering.

13. The method of claim 9, further comprising:
generating a graph of the plurality of nodes, wherein the clustering further comprises adding edges in the graph between pairs of clusters of the plurality of clusters which have at least one node of the plurality of nodes assigned to both clusters of the pair of clusters.

14. The method of claim 13, wherein the notification comprises the graph.

15. The method of claim 1, wherein the time series data set comprises measures of a database throughput, wherein the at least one anomaly comprises at least one outlier among the measures of database throughput.

16. The method of claim 15, further comprising:
performing at least one remedial action in response to the notification, wherein the at least one remedial action comprises at least one of:
changing at least one setting of a database associated with the measures of database throughput; or
changing at least one aspect of a communication network associated with the database.

17. The method of claim 1, wherein the time series data set comprises measures of at least one type of biometric data, wherein the at least one anomaly comprises at least one outlier among the measures of the at least one type of biometric data.

18. The method of claim 17, wherein the notification is sent to at least one of:
a device of a user from which the biometric data is collected; or
a computing system of at least one medical provider associated with the user.

19. A non-transitory computer-readable medium storing instructions which, when executed by a processing system including at least one processor, cause the processing system to perform operations, the operations comprising:
generating a plurality of subsequences of a time series data set;
converting the plurality of subsequences to a plurality of frequency domain point sets;
computing pairwise distances of the plurality of frequency domain point sets;
projecting the plurality of frequency domain point sets into a lower dimensional space in accordance with the pairwise distances, wherein the projecting maps each of plurality of frequency domain point sets to a node of a plurality of nodes in the lower dimensional space; and
generating a notification of at least one isolated node of the plurality of nodes, wherein the at least one isolated node represents at least one anomaly in the time series data set.

20. An apparatus comprising:
a processing system including at least one processor; and
a computer-readable medium storing instructions which, when executed by the processing system, cause the processing system to perform operations, the operations comprising:
generating a plurality of subsequences of a time series data set;
converting the plurality of subsequences to a plurality of frequency domain point sets;
computing pairwise distances of the plurality of frequency domain point sets;
projecting the plurality of frequency domain point sets into a lower dimensional space in accordance with the pairwise distances, wherein the projecting maps each of plurality of frequency domain point sets to a node of a plurality of nodes in the lower dimensional space; and
generating a notification of at least one isolated node of the plurality of nodes, wherein the at least one isolated node represents at least one anomaly in the time series data set.
